(19) United States
(12) Patent Application Publication
(10) Pub. No.: US 2008/0005562 A1
(43) Pub. Date: Jan. 3, 2008

(54) Public key infrastructure certificate entrustment

(75) Inventors: Dale A. Sather, Seattle, WA (US); Guillaume Simonnet, Bellevue, WA (US); Shannon J. Chan, Bellevue, WA (US); Thomas W. Kuehnel, Seattle, WA (US); William Robert Williams, Renton, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/301,858

(22) Filed: Dec. 13, 2005

(51) Int. Cl. H04L 9/00

(52) U.S. Cl. 713/168

(57) ABSTRACT

Establishing a chain of trust in a public key infrastructure can be costly, time consuming and requires nearly constant access to the appropriate network-based authorities. Local trust between devices is established using a combination of a personal identification number (PIN) delivered out-of-band and self-signed certificates. The client may present the PIN to an electronic device such as a projector or printer so the electronic device can trust the client. The electronic device may present a self-signed digital certificate with the electronic device UUID based on a hash of the electronic device public key from the certificate.

### BACKGROUND

Establishing trust between electronic devices is important for the security of transactions and for preventing a variety of annoying, malicious, or destructive attacks. One method of establishing trust is public key infrastructure (PKI). Most often, PKI relies on each participant having a private key and a public key for use in cryptographic functions. The public and private keys are used cooperatively for digital signatures and for encrypting/decrypting. Trust between participants is established using digital certificates for each participant, with each digital certificate traceable to a root certificate authority. The root certificate authority takes responsibility for the integrity of each digital certificate in its hierarchy, as long as each participant routinely verifies other digital certificates against a certificate revocation list. There is a cost, often significant, associated with developing and maintaining a root certificate authority and a hierarchy of intermediate and user certificates. As well, there is a cost associated with routinely verifying participant digital certificates. In some cases, each participant may not have free access to the root certificate authority or its associated certificate revocation list causing the chain of trust to be suspect.

For some uses, the use of a full public key infrastructure is both prudent and cost-effective compared to the risks associated with fraud or other attacks. However, in other cases, the cost associated with a trusted public key infrastructure cannot be justified based on either the quantity of devices involved or the relatively low risk associated with typical transactions between devices. For example, a series of conference rooms may each have projection equipment available to conference room attendees with portable computers or to electronically connected remote attendees. There is a real, but low, risk that a non-attendee may capture the conference room projector to deny access to the service either maliciously or as a prank. The cost of supplying and maintaining fully trusted public key infrastructure could hardly be justified relative to the low risk and relatively minimal consequences of such an attack. Nonetheless, the risk is real and the cost in inconvenience or correcting such a problem could be locally significant.

### SUMMARY

Self-signed certificates are one alternative to the high cost and high maintenance associated with full, trusted, public key infrastructure. Participating electronic devices may generate or be assigned a password or passphrase, and an identifier. In some embodiments, the identifier is a function of the universal unique identifier (UUID) of the electronic device. These two elements, the password and the identifier, may be used together or separately to aid in establishing trust between the electronic device and a requesting party or client. In one embodiment the two parts are distributed together, creating a longer, but more secure personal identification number (PIN). In another embodiment, only the password is used for the PIN. In this embodiment the identifier is a hash of the public key associated with the device which is also used as the UUID of the electronic device. The PIN may be delivered via a channel separate from that used for a subsequent electronic connection with a client and may be used to establish sufficient trust in self-signed certificate applications.

The PIN may be transported via e-mail, entered from a sticker on the device itself, or displayed on a monitor or other display associated with the device. For example, a projector may display the PIN on the projection or a printer or may display a PIN on a local multi-line display. The PIN can be subsequently used in establishing trust of the client by the electronic device. To establish trust of the electronic device by the client, the public key of electronic device may be operated on, for example, hashed, to give a value that is set equal to the universal unique identifier (UUID) of the electronic device. Since the UUID resolves to the device and the digital certificate supplied by the device is linked to the UUID, trust of the electronic device by the client can also be established. Supplemental techniques described below, such as including a portion of the UUID in the PIN may be useful for increasing confidence in the trusted relationship.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is flow chart of a method of establishing trust between a client and an electronic device;

FIG. 4 is a flow chart of an alternate method of establishing trust between a client and an electronic device; and

FIG. 5 is a flow chart of a detail of the method of FIG. 4 for calculating a PIN value.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

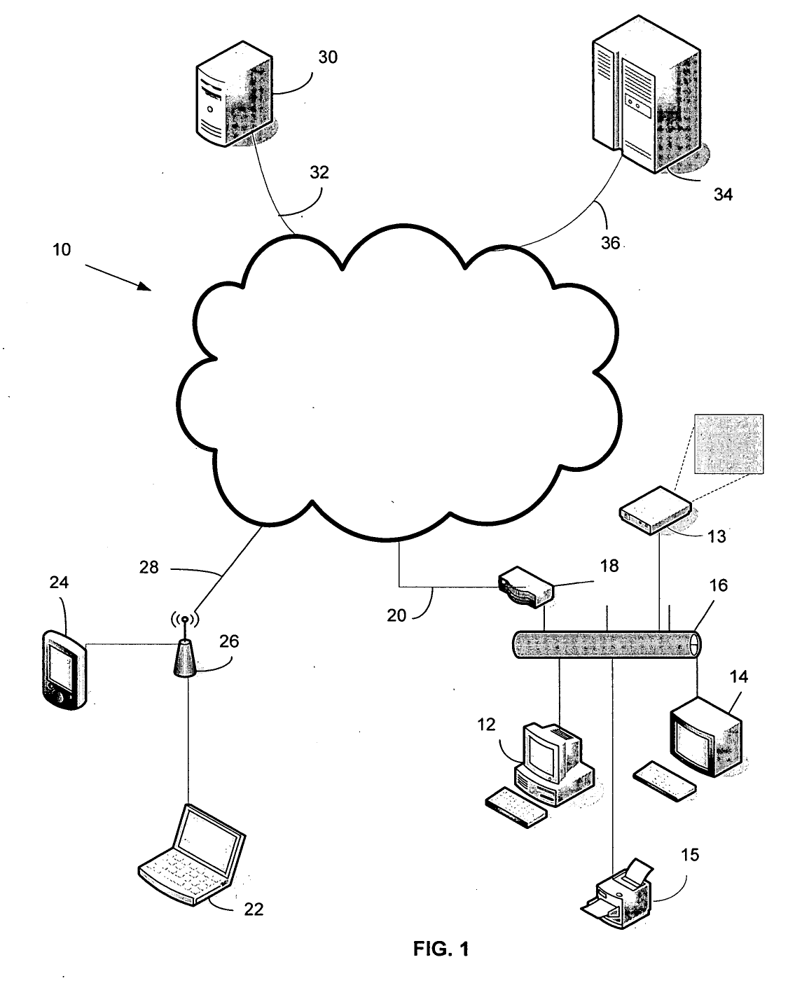

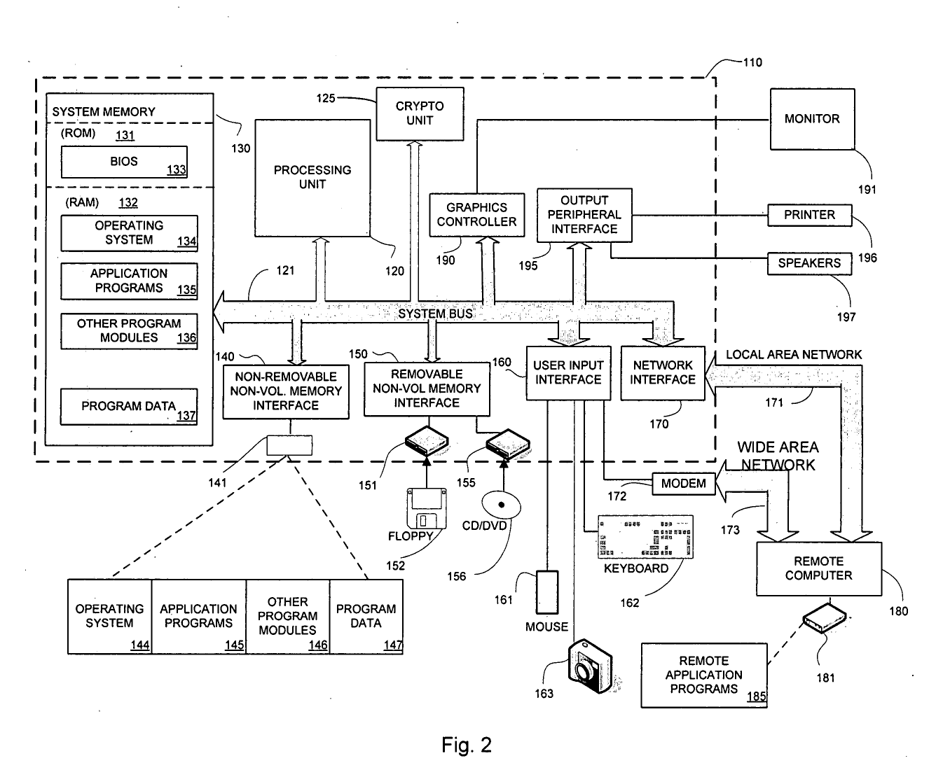

FIGS. 1 and 2 provide a structural basis for the network and computational platforms related to the instant disclosure.

FIG. 1 illustrates a network 10 that may be used to implement a dynamic software provisioning system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. Other networked resources, such as a projector 13 and printer 15 may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. In one embodiment, the server 30 may function as a presentation server for serving presentation data on the network 10. In another embodiment, the mainframe 34 may function as a broadcast server to make available data to a large number of users, for example, corporate financial results presentations. The network 10 may be useful for supporting peer-to-peer network traffic. It should be noted that peer-to-peer network traffic may pass through intermediate hosts, including servers, proxies, routers, switches, and other elements whose role is to facilitate the transmission of data between the communicating hosts.

FIG. 2. illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In addition, the cryptographic unit 125 may include an RNG (random number generator) which is used to provide random numbers. In other embodiments, the functions of the cryptographic unit may be instantiated in software or firmware and may run via the operating system.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

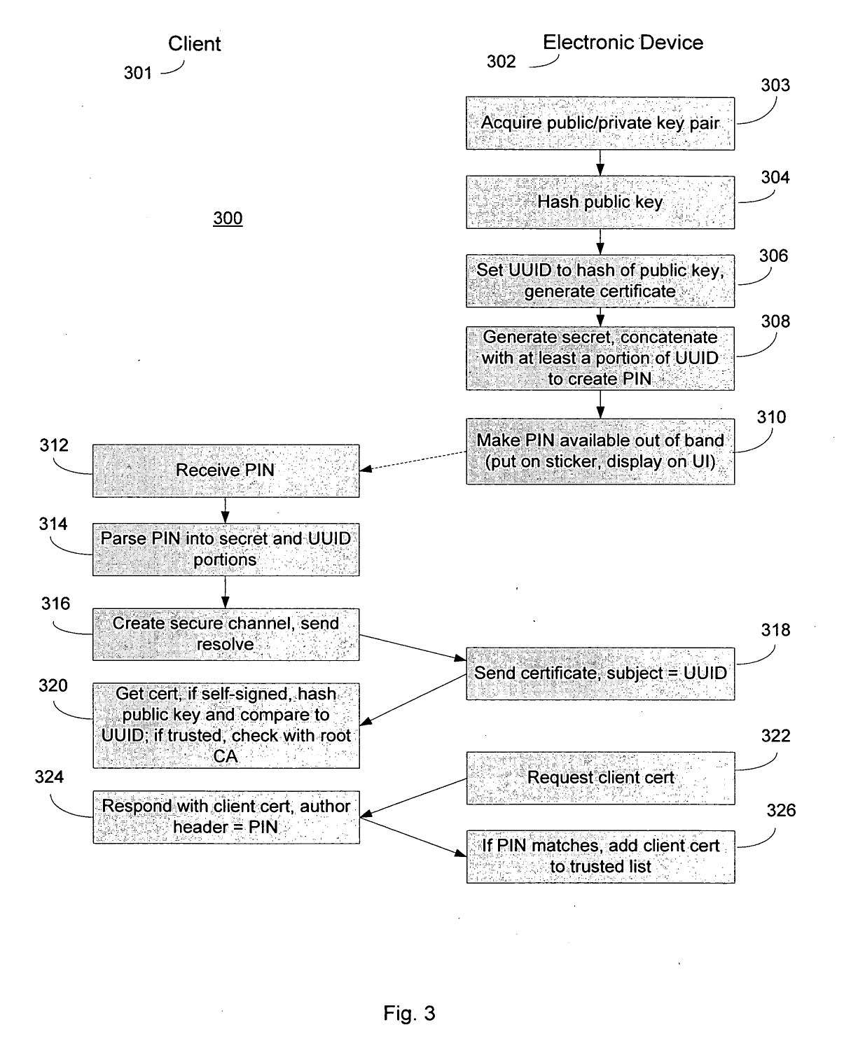

FIG. 3 is a flow chart of a method 300 of establishing trust between a representative client 301 and a representative electronic device 302. The client 301 may be any electronic device or user-oriented, processor-based equipment that may want to establish a trusted relationship with an electronic device 302. Examples of possible clients include, but are not limited to, a laptop 22, a personal computer 12, a personal digital assistant 24, a cellular telephone (not depicted) and the like. The electronic device 110, may be a computer 12, or other processor-based device or peripheral such as a printer 15, a projector 13, a cellular telephone (not depicted), a personal digital assistant 24, a network access point 26, a scanner (not depicted) and the like. Both the client 301 and the electronic device 302 may have some or all of the functional components of the computer of FIG. 2, including, but not limited to, a processing unit 120, at least one of the memory architectures 130, 141 151 155, a network interface 170, and a hardware or software implementation of the cryptographic unit 125.

The electronic device 302 may acquire a public/private key pair at block 303. The generation of public/private key pairs is well known in the art of cryptography, particularly asymmetric cryptography. RSA and elliptic curve are both examples of asymmetric cryptographic methods for generating and using public/private key pairs. RSA keys are often in the range of 1 kilobit, while elliptic curve keys are often in the range of 160 bits but may vary based on the cryptographic strength desired. As is known, one of the two keys of the key pair is kept secret and is designated the private key, the other key is made available to other entities and is designated the public key. The key pair may be produced internally using a cryptographic function or may received from an outside source, for example, from a hardware security module in a secure manufacturing environment.

At block 304, a cryptographic derivative of the public key may be generated, such as a hash, using any of many known hash algorithms, such as SHA-1 or MD5 or a more complex algorithm as described below. The hash of the public key may be used as the universal unique identifier (UUID) of the electronic device 302 at block 306. In some networking implementations, such as web services, the UUID is used to identify a device using an address resolution protocol such as Web Services-Discovery. The linking of the UUID of the electronic device 302 to the public key associated with the electronic device 302 may be used later in establishing the trusted relationship.

A digital certificate may be created that has fields including the public key and the UUID. Digital certificates, or just certificates, are known. One common standard defining the format and fields for digital certificates is the X.509 standard. Other fields may be the expiration date, the signing authority, etc. In one embodiment, the ‘subject’ field may be set to the UUID. As a reminder, the UUID is the hash of the public key, so the two are linked. The certificate may be self-signed, that is a signature field of the certificate may be encrypted using the certificate holders own private key, see block 303. In one embodiment, the certificate may be fully qualified and signed by a recognized certificate authority.

At block 308, a personal identification number (PIN) may be created. In the strictest sense this is not a PIN, since this is not related to a person. In most applications a PIN is a limit number set, usually 4 numbers. As used herein, the PIN could be any phrase, word, character set, or description. However, since the PIN in this application is used to identify a particular endpoint, such as a device, it will be used for convenience. In one embodiment, the PIN may be a concatenation of a number, such as a random number, with at least a portion of the UUID. The random number portion may be thought of as the secret part of the PIN, although it is displayed in the clear in some embodiments. The full UUID may be concatenated with the secret when using the UUID to resolve the address of the electronic device 302. Shortening the UUID portion may be done to make subsequent entry of the PIN easier, when done manually, but the UUID is no longer available for use as an address and other discovery processes may be necessary to find the electronic device 302.

The PIN may then be made available to clients using an out-of-band channel at block 310. If an in-band channel is the network mechanism ultimately used for communication between the client 301 and the electronic device 302, then an out-of-band channel is anything else. For example, the out-of-band channel may include but is not limited to electronic mail, a computer display 190 associated with the electronic device 302, a sticker (not depicted) or label attached to the electronic device 302, and a sticker or label attached to a remote control (not depicted) associated with the electronic device 302.

At block 312, the client 301 may receive the PIN electronically, for example, by email, or a user may enter the PIN value via a user interface when viewed on one of the locations mentioned above. At block 314, the PIN may then be parsed into two portions, the secret portion and the UUID portion. The client 301 may use the UUID to resolve the address of the electronic device 302 and a secure channel may be created at block 316. The electronic device 302 participates in the secure channel creation and may then reply, at block 318, with the self-signed certificate. The UUID may be embedded in the certificate, for example, in the subject field.

Proceeding to block 320, when the client 301 receives the certificate, it may determine if it is a trusted certificate or a self-signed certificate. If the certificate is trusted, the root authority may be checked, and if valid, the certificate accepted and the electronic device 302 given a trusted status. If the certificate is self-signed, the client 301 may extract the public key from the certificate and perform the agreed-to hash function. If the hash of the public key matches the UUID in the certificate, and if the electronic device 302 was discovered at that same UUID, the electronic device 302 may at that point be given trusted status by the client 301.

With the electronic device 302 trusted by the client 301, it remains for the electronic device 302 to establish trust with the client 301. At block 322 the electronic device 302 may send a message to the client 301 requesting a certificate or other identifier. The client 301 may respond at block 324 with a certificate with the PIN embedded in the certificate, for example, in the header field. The electronic device 302 may analyze the certificate at block 326 to determine if the PIN received in the certificate matches the PIN of the electronic device 302. If they match, the electronic device 302 has an assurance that the client 301 has received the PIN and trust may be extended by placing the client certificate in a trusted store.

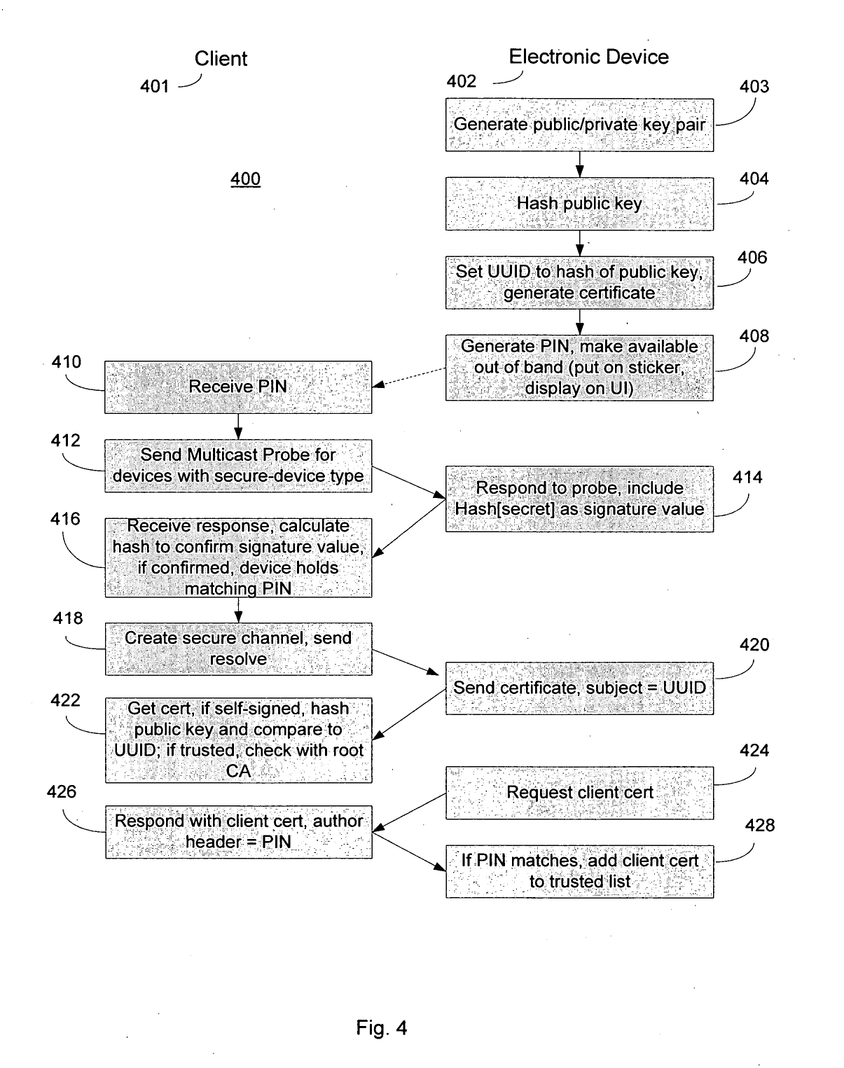

Referring to FIG. 4, a flow chart of an alternate method of establishing trust between a client and an electronic device is discussed and described. As above, the client and electronic device may any combination of a number of devices. This exemplary embodiment allows the use of a potentially shorter PIN than that of the previous example.

The electronic device 402 may acquire a public/private key pair at block 403. The generation of public/private key pairs is well known in the art of cryptography, particularly asymmetric cryptography. RSA and elliptic curve are both examples of asymmetric cryptographic methods for generating and using public/private key pairs. RSA keys are often in the range of 1 kilobit, while elliptic curve keys are often in the range of 160 bits but may vary based on the cryptographic strength desired. As is known, one of the two keys of the key pair is kept secret and is designated the private key, the other key is made available to other entities and is designated the public key. The key pair may be produced internally using a cryptographic function or may received from an outside source, for example, a hardware security module in a secure manufacturing environment.

At block 404, a cryptographic derivative of the public key may be generated, such as a hash, using any of many known hash algorithms, such as SHA-1 or MD5 or another algorithm, described below. The hash of the public key may be used as the universal unique identifier (UUID) of the electronic device 402 at block 406. In some networking implementations, such as web services, the UUID is used to identify a device using an address resolution protocol such as Web Services-Discovery. The linking of the UUID of the electronic device 402 to the public key associated with the electronic device 402 may be used later in establishing the trusted relationship.

A digital certificate may be created that includes the public key and the UUID. Digital certificates, or just certificates, are known. One common standard defining the format and fields for digital certificates is the X.509 standard. Other fields may be the expiration date, the signing authority, etc. In one embodiment, the ‘subject’ field is set to the UUID. As a reminder, the UUID is the hash of the public key, so the two are linked. The certificate may be self-signed, that is the signature field of the cert may be encrypted using the certificate holders own private key, see block 403. In one embodiment, the certificate may be fully qualified and signed by a recognized certificate authority.

At block 408, a PIN may be generated and made available using out-of-band channels the same as or similar to those described above, for example, a displayed value or a sticker attached to the electronic device 402. The PIN may simply be a random number or other number denoted as a secret for the purpose of this discussion.

At block 410, the client 401 receives the PIN either via an out-of-band transmission, such as an email, or may be manually entered by a user viewing the published PIN value. The client may then send a multi-cast probe, as described in the Web Services Discovery protocol, with a setting of secure devices, that is, a probe looking for a response from a secure device. The scope of the multi-cast probe may be confined to a particular area, for example, geographically or by network locale.

The electronic device 402, at block 414 may respond to the probe. The response, to use a Web Services embodiment as an example, may include an XML security header with the signature value set to the hash of the PIN. Since the hash of the secret is being sent, and the PIN may subsequently be involved in establishing trust, the PIN is susceptible to a dictionary attack by an entity that does not actually hold the PIN. To increase the difficulty in succeeding with a dictionary attack, an advanced hash algorithm may be used. For example, a combination of a PBKDF2 algorithm may be used with an HMAC-SHA-1 hash function. Salt may be added to increase the calculation time and overall difficulty of performing the dictionary attack.

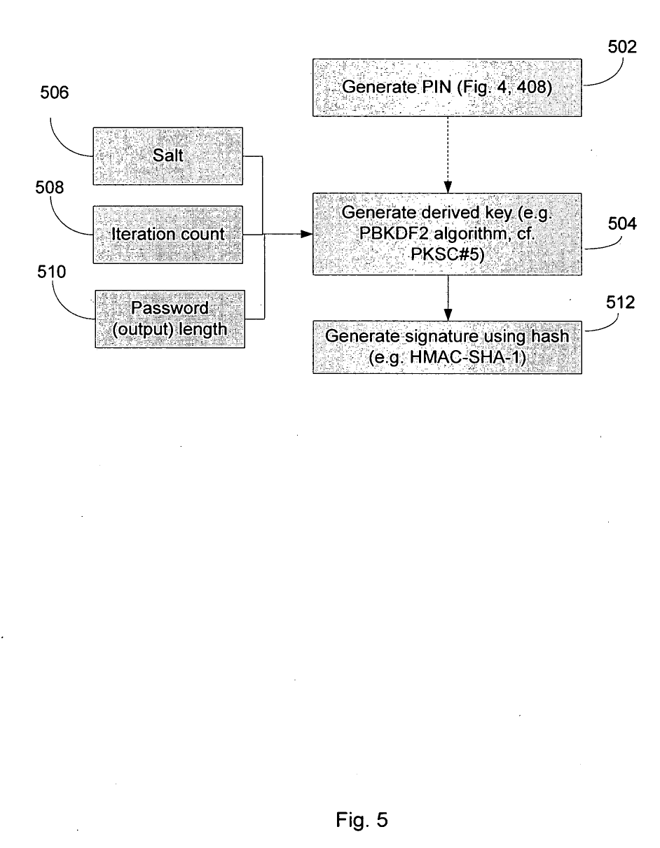

Turning briefly to FIG. 5, this exemplary hash algorithm is described. The PDBDF2 algorithm is known and documented in the PKSC#5 version 2 standard and is available on both cryptography web sites and in widely available cryptography books. This is an implementation of the key derivation function KDF-2 from PKCS #5: Password-Based Cryptography (PBE). This KDF is essentially a way to transform a password and a salt into a stream of random bytes, which may then be used to initialize a cipher or a MAC, where the PIN is the password and the MAC is the hash output. Briefly, the PIN is generated at block 502, for example, following the process of FIG. 4, block 408. At block 504, the PBKDF2 algorithm takes the PIN as input, as well as the salt 506 and an iteration count 508. A final input, specifying the output length 510, may vary, but in one embodiment is 128 bits.

The PBKDF2 algorithm uses the iteration count to specify the number of cycles or turns the internal calculation routine uses to process the inputs. In some password generating applications, the iteration count may be set to 1000. In one exemplary embodiment, the iteration count may be set high, on the order of 50,000, again, to increase the time and difficulty required to guess the PIN. When the difficulty or cost (in terms of time and resources) is increased high enough and the value of the attack is relatively low, most attackers are discouraged from the attempt. The output of the PBKDF2 algorithm may be passed to an HMAC-SHA-1 algorithm increase the hash strength. The combination of PBKDF2 and HMAC-SHA-1 is known. The resultant output may be passed to the client 401.

Returning to FIG. 4, the probe response, including the hash, and optionally, the salt, and the iteration count may be sent to the client 401 at block 414. The client 401 may then, at block 416, use the PIN received at step 410 and calculate its own hash value using the process of FIG. 5. If the locally calculated hash matches that received, the client 401 may assume with confidence that the electronic device 402 has the PIN. At block 418, the client 401 and electronic device 402 may create a secure channel, such as secure sockets library (SSL) over an Internet protocol channel, for further communication. The secure channel in itself does not establish trust, only that future transmissions have integrity. The electronic device 402 may send, at block 420, a message including a self-signed certificate that includes the UUID of the electronic device 402, for example, in the subject field. When the client 401 receives the certificate at block 422, the client 401 may determine if the certificate is self-signed. If the certificate is self-signed then the client 401 may extract the public key and see if it hashes to the UUID of the electronic device 402. When the values match, in combination with verifying that the electronic device 402 has the PIN at block 416, then the client 401 may grant trusted status to the electronic device 402.

In cases where the certificate is trusted, i.e. signed by a root authority, the client 401 may verify the authenticity using a stored root public key and/or check with the certificate authority for authenticity and possible revocation.

With the electronic device 402 trusted by the client 401, it remains for the electronic device 402 to establish trust with the client 401. At block 424 the electronic device 402 may send a message to the client 401 requesting a certificate or other identifier. The client 401 may respond at block 426 with a certificate with the PIN embedded in the certificate, for example, in the header field. The electronic device 402 may analyze the certificate at block 428 to determine if the PIN received in the certificate matches the PIN of the electronic device 402 (refer to block 408). If the two match, the electronic device 402 has an assurance that the client 401 has received the PIN and trust may be extended by placing the client certificate in a trusted store. Depending on the local requirements, the lifetime of the certificates may be set with different terms, for example, one day vs. 1 year, depending on the accessibility of the electronic device 402 from wide area networks, or the amount of visitor traffic common in a given facility.

By following the authentication process outlined, a client device may fairly easily establish contact with an electronic device for the purpose of communicating data and, in many cases, sharing resources. The example of the conference room projector and client laptop illustrates the usefulness of a quick and easy connection, the value of the trusted relationship with respect to jamming and misuse, and the convenience of retaining trusted status for clients and electronic devices that may be in frequent contact with each other. For example, when a particular group routinely uses the same conference room, long-term trusted status may reduce the time to establish a session and start a meeting. However, in another environment, such as a public conferencing facility at an airport, short-lived certificates and frequently regenerated key pairs and/or PIN numbers may be used to assure availability.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of establishing trust between a client and an electronic device comprising:
receiving at the client a personal identification number (PIN) from the electronic device on an out-of-band channel;
receiving a public key infrastructure (PKI) certificate corresponding to the electronic device, the certificate comprising a public key;
hashing the public key from the certificate;
matching a hash of the public key to an address identifier for the electronic device to establish trust of the electronic device by the client; and
sending at least a portion of the PIN to the electronic device for use by the electronic device in establishing trust of the client.

2. The method of claim 1, further comprising setting an address identifier for the electronic device to be at least a portion of the hash of the public key.

3. The method of claim 1, wherein the PIN comprises a random number and at least a portion of a hash of the public key.

4. The method of claim 3, wherein matching the hash of the public key to an address identifier for the electronic device comprises matching the portion of the PIN comprising the hash of the public key to an address identifier for the electronic device.

5. The method of claim 1, wherein matching the hash of the public key to an address identifier for the electronic device comprises matching the hash of the public key to a designated field in the certificate containing the address identifier.

6. The method of claim 5, wherein the designated field in the certificate is the subject field.

7. The method of claim 1, wherein the address identifier for the electronic device is a Universal Unique Identifier (UUID).

8. The method of claim 1, wherein the PIN comprises an identification number.

9. The method of claim 1, wherein the PIN comprises a random number.

10. The method of claim 1, further comprising:
receiving a first hash of the PIN from the electronic device in response to a request from the client;
calculating a second hash of the PIN at the client; and
comparing the first and second hashes of the PIN to confirm the electronic device is in possession of the PIN.

11. The method of claim 10, wherein calculating the second hash comprises calculating the second hash using a PBKDF2 algorithm with an iteration count greater than 5000.

12. The method of claim 1, wherein receiving at the client the PIN number comprises receiving at the client the PIN number via one of an electronic mail, a computer display associated with the electronic device, a sticker attached to the electronic device, and a sticker attached to a remote control associated with the electronic device.

13. The method of claim 1, wherein the electronic device is one of a printer, a projector, a cellular telephone, a network access point, a scanner, and a computer.

14. A computer-readable medium having computer executable instructions for implementing a method comprising:
storing a personal identification number (PIN);
obtaining a public/private key pair for cryptographic operations;
hashing the public key to create an address identity;
creating a digital certificate comprising the public key and the address identity;
signing the digital certificate using the private key to create a self-signed certificate;
sending the self-signed certificate to a requesting entity for use in establishing trust by a client entity; and
receiving a form of the PIN for use in establishing trust of the client entity.

15. The computer-readable medium of claim 13, wherein obtaining comprises generating a public/private key pair.

16. The computer-readable medium of claim 13, wherein the address identifier is a unique universal identifier (UUID) for use in a web services discovery process.

17. The computer-readable medium of claim 13, wherein storing the PIN comprises generating the PIN including a first portion of the PIN comprising a random number and second portion of the PIN comprising the address identity.

18. The computer-readable medium of claim 13, further comprising responding to a web services probe with a probe match including a security header signature value calculated using the address identity as an input to a PBKDF2 algorithm.

19. A computer for use in connecting to an electronic device using a non-trusted public key infrastructure comprising:
a cryptographic unit;
a processor for executing computer executable instructions; and
a computer-readable medium storing computer executable instructions for executing a method comprising:
storing a personal identification number (PIN) received via a first channel corresponding to the electronic device;
receiving a self-signed digital certificate from the electronic device via a second channel;
operating on the PIN to derive a first value;
directing the cryptographic unit to create a hash of the public key contained in the self-signed digital certificate to create a second value; and
comparing the first value to second value to establish trust of the electronic device by the computer when the first and second values match.

20. The computer of claim 19, wherein the computer-readable medium stores computer executable instructions for directing the cryptographic unit to derive the first value from the PIN using a hash function that includes an HMAC-SHA-1 function.
